(19) United States
(12) Patent Application Publication
(10) Pub. No.: US 2015/0010697 A1
(43) Pub. Date: Jan. 8, 2015

(54) ELECTRICAL INSULATING RESIN BASED ON ISOHEXIDEDIOL DIGLYCIDYL ETHERS

(71) Applicant: ELANTAS GmbH, Wesel (DE)

(72) Inventors: Giancarlo Soncini, Rio Claro (BR); Gunther Baumgarten, Hamburg (DE); Klaus-Wilhelm Lienert, Hamburg (DE)

(73) Assignee: ELANTAS GmbH, Wesel (DE)

(21) Appl. No.: 14/378,607

(22) PCT Filed: Feb. 13, 2013
(86) PCT No.: PCT/EP2013/052824

§ 371 Date: Aug. 13, 2014

(30) Foreign Application Priority Data
Feb. 14, 2012 (DE) 10 2012 202 161.2

(51) Int. Cl. H01B 3/40; H01B 13/16; H01B 19/04; C08G 59/22; H01B 19/02

(52) U.S. Cl. CPC H01B 3/40; C08G 59/22; H01B 19/02; H01B 19/04; H01B 13/16; H01B 13/165
USPC 427/116; 427/58

(57) ABSTRACT

Electrical insulating resin comprising
A) isohexidediol diglycidyl ether,
B) a hardener,
C) an optional filler,
D) further optional additives.

The isohexidediol diglycidyl ether is preferably an isosorbide diglycidyl ether, isomannide diglycidyl ether or isoidide diglycidyl ether.

The invention relates to an electrical insulating resin based on isohexidediol diglycidyl ethers and their use.

Electrical insulation resins based on epoxy resins are known and have often been described.

Electrical potting compounds based on bisphenol A diglycidyl ethers and bisphenol F diglycidyl ethers are described in DE 4 206 733. These potting compounds comprise dolomite as filler and methyltetrahydrophthalic anhydride as hardener. The curing is effected at 80° C. to 100° C. and a post-curing at 130° C. to 140° C. over a period of 2 to 4 hours.

Cycloaliphatic epoxy resins are described in DE 4 139 877 and EP 545 506. These resins are 3,4-epoxycyclohexylmethyl 3,4-epoxycyclohexylcarboxylate and bis(3,4-epoxycyclohexylmethyl) adipate. Dolomite is used as filler and tetrahydrophthalic anhydride is used as hardener.

A curable casting resin mixture based on cyclododecane triepoxide with phthalic anhydride or 4,4′-diamino-3,3′-dimethyldicyclohexylmethane as hardeners is described in CH 424 256.

The base epoxy resins may also be modified. In WO 98/04609, for example, silicone-modified epoxy resins are described.

and aluminium oxide are also used as fillers for epoxy resins, also in combination with short glass fibres, as described in DE 1 570 211. Rubber powder is also used as organic filler, as described in DE 1 495 072.

Epoxy resins are cured using dicarboxylic anhydrides, diamines and their derivatives, and also using Lewis acids, such as complexes of boron trichloride and boron trifluoride. The curing of epoxy resins is described inter alia in books such as “Epoxidverbindungen und Epoxidharze” (Epoxide compounds and epoxy resins) by A. M. Paquin, Springer-Verlag, 1958 or “Die Kunststoffe und ihre Eigenschaften” (Plastics and their properties) by H. Domininghaus, VDI Verlag, 1988.

In the field of electrical engineering, epoxy resins have proven to be of value in many different applications. DE 19 809 572 describes a casting resin transformer. In DE 4 132 982 the use of epoxy resins for stator encapsulation is described. DE 1 220 500 describes the use of casting resins for producing high-voltage insulators. DE 1 209 650 describes the encapsulation of winding heads with a casting resin. The encapsulation of a high-voltage coil is described in DE 1 207 605. Also, epoxy resins have proven useful for impregnating traction motors (“Isolationssysteme für Traktionsmotoren” (Insulation systems for traction motors) VonRoll, CH-4426 Breitenbach).

Epoxy resins based on bisphenol A diglycidyl ethers are of toxicological concern due to the free bisphenol A content. Also, these resins have a viscosity in the range from 9000 to 13 000 mPa at 25° C. and therefore too high a viscosity for many applications.

Although cycloaliphatic epoxy resins have a low viscosity, they have a strong sensitising effect.

US2008/0009599 A1 describes glycidyl ethers of anhydro-sugars such as isosorbide, isomannide and isoidide, as well as resins obtained therefrom by curing with aliphatic and aromatic polyamines.

The object of the present invention is to provide electrical insulating resin formulations not having the above-described disadvantages. In particular, they should be of no toxicological concern, and have a low viscosity, short gel times, and also good curing properties and good bond strength.

The object is achieved by an electrical insulating resin comprising

A) diglycidyl ether of an isohexidediol

B) a hardener

C) an optional filler

D) further optional additives.

We have surprisingly found that the diglycidyl ether of an isohexidediol is very useful as an epoxy resin for electrical insulating applications.

Isohexidediols are obtained by anhydride formation from the corresponding hexitols by eliminating 2 molecules of water. Preference is given to the diglycidyl ethers of isosorbide, isomannide and isoidide. These are described for example in U.S. Pat. No. 3,272,845.

Preference is given to isosorbide diglycidyl ether.

Isosorbide (1,4:3,6-dianhydro-D-sorbitol) is prepared from glucose. The isosorbide diglycidyl ether can subsequently be prepared therefrom by various methods, as described for example in WO 2008/147473. Industrially available isosorbide diglycidyl ether has a viscosity of approx. 870 mPa at 25° C. and an epoxide equivalent weight of 166 EEW/g.

Isomannide diglycidyl ether and isoidide diglycidyl ether have similar properties to isosorbide diglycidyl ether.

The electrical insulating resin according to the invention has excellent adhesion and excellent electrical insulating properties in the cured state. The resin can be used alone or in combination with solid insulating materials (tapes, etc.), to insulate electrical devices such as motors, transformers and generators.

Isosorbide diglycidyl ether and also the other isohexidediol diglycidyl ethers may be used in various electrical insulating resin formulations and be used in place of bisphenol A diglycidyl ether for example. The amount of the isohexidediol diglycidyl ether is selected according to the differing epoxy equivalents of the isohexidediol diglycidyl ether and of the epoxy compounds which are replaced by the isohexidediol diglycidyl ether.

The electrical insulating resin according to the invention comprises at least one hardener B). Suitable hardeners for epoxy resins are dicarboxylic acids or dicarboxylic anhydrides, diprimary diamines or polyamines, or Lewis acids.

In one embodiment of the invention the hardener B) comprises one or more dicarboxylic anhydrides or dicarboxylic anhydrides. Suitable dicarboxylic anhydride or dicarboxylic anhydride hardeners are, for example, tetrahydrophthalic anhydride, methyltetrahydrophthalic anhydride, hexahydrophthalic anhydride and dodecylsuccinic anhydride. Preference is given to tetrahydrophthalic anhydride and hexahydrophthalic anhydride.

In general, 75% to 100%, preferably 85% to 100%, of the anhydride equivalent of the anhydride hardener is used per epoxy equivalent of the isohexidediol diglycidyl ether.

In addition to the hardener B), a reaction accelerator may be present in the resins. If a dicarboxylic anhydride is used as hardener B), then a reaction accelerator is preferably included. Suitable reaction accelerators are tertiary amines, such as benzyldimethylamine, triethylamine, triethanolamine and N-methylmorpholine.

In a further embodiment, the hardener B) comprises diprimary diamines or polyamines. Suitable hardeners are, for example, 1,6-hexylenediamine, isophoronediamine, xylylenediamine, diethylenetriamine, triethylenetetramine, tetraethylenepentamine, pentamethylenehexamine and polyether polyamines such as Jeffamine D 400.

In general, 75% to 100% of the equivalent amine amount, preferably 85% to 100% of the equivalent amine amount, is used as diprimary diamine or polyamine per epoxy equivalent of the isohexidediol diglycidyl ether.

In a further embodiment, the hardener B) comprises a Lewis acid. Lewis acids suitable as hardeners are, for example, boron trifluoride or boron trichloride complexes, particularly amine complexes. Examples are the monoethanolamine, ammonia and also piperidine, trimethylamine, hexamethylenetetramine or pyridine complexes of boron trifluoride and also the dimethyloctylamine or pyridine complexes of boron trichloride.

In general, 1 to 6% by weight, preferably 2 to 5% by weight, of the Lewis acid is used, based on the total mass of the electrical insulating resin.

In a specific embodiment of the invention, the hardener B) comprises a boron trichloride-amine complex.

The electrical insulating resin may contain one or more fillers. Suitable fillers are selected, for example, from the group consisting of dolomite, chalk, fused silica, quartz flour, aluminium hydroxide, magnesium hydroxide and mixtures thereof.

The filler(s) can be present in amounts of 20 to 70% by weight, based on the total mass of the electrical insulating resin.

If the electrical insulating resin is a casting resin, then it preferably comprises a filler. If the electrical insulating resin is an impregnating agent, then it preferably does not comprise a filler.

The electrical insulating resin may contain further additives D). Additives are, in addition to the reaction accelerator already mentioned, wetting aids, levelling agents and pigments.

Generally, additives may be present in amounts of 0 to 6% by weight, based on the total mass of the electrical insulating resin.

The electrical insulating resin can additionally comprise a reactive diluent. Suitable reactive diluents are diglycidyl ethers of diols or long-chain mono-alcohols, such as butanediol diglycidyl ether, hexanediol diglycidyl ether, phenyl glycidyl ether, cresyl glycidyl ether, decyl glycidyl ether, dodecyl glycidyl ether, polyethylene glycol monoglycidyl ether and poly-THF monoglycidyl ether. If these are present, they may be present in amounts of up to 20% by weight, based on the total mass of the electrical insulating resin, but lead to soft moulding materials. Preferably the electrical insulating resins do not contain any reactive diluent.

The formulation according to the invention is introduced into the windings of an electrical machine by current conventional procedures, such as dipping, dip rolling, trickling, pouring, vacuum or vacuum-pressure impregnation. This is followed by thermal curing, by curing either in an oven or by resistive heating of the windings or by a combination of these options.

The present invention also relates to the use of isohexidediol diglycidyl ethers, particularly isosorbide diglycidyl ether, isomannide diglycidyl ether and isoidide diglycidyl ether, in electrical insulating resins for impregnating electrical machines, for encapsulating transformers, electrical coils and electric motors and for producing high-voltage insulators.

The present invention also relates to the use of the above-described electrical insulating resins for impregnating electric machines, particularly for impregnating high-voltage electric machines. The present invention further provides for the use of electrical insulating resins for encapsulating transformers, electrical coils, for fully encapsulating electric motors and for the production of high-voltage insulators.

The invention is described in more detail with reference to examples. Testing is conducted according to DIN and IEC standards.

### EXAMPLES

The present invention is illustrated by, but not in any way restricted to, the examples.

### Comparative Example 1

53.33 g of bisphenol A diglycidyl ether (EEW=190), 46.53 g of methyltetrahydrophthalic anhydride and 0.14 g of benzyldimethylamine are mixed and used in further experiments. The formulation contains 100% of the theoretical hardener amount. The gel time is 20′20″ at 120° C. and 11′19″ at 130° C. The viscosity is 656 mPa·s at 25° C.

### Example 2

49.88 of isosorbide diglycidyl ether (EEW=166), 49.97 of methyltetrahydrophthalic anhydride and 0.15 g of benzyldimethylamine are mixed and used in further experiments. The formulation contains 100% of the theoretical hardener amount. The gel time is 11′01″ at 120° C. and 5′12″ at 130° C. The viscosity is 421 mPa at 25° C.

Curing Experiments

Twisted rods according to IEC 61033 are impregnated with the resins. They are cured for 3 hours at 130° C. and the bond strengths are determined as a function of temperature.

These are, for comparative example 1,

589 N (23° C.), 69 N (155° C.), 42 N (180° C.);

For example 2 the bond strengths are

632 N (23° C.), 57 N (155° C.), 452 N (180° C.)

### Comparative Example 3

57.14 g of bisphenol A diglycidyl ether, 42.73 g of methyltetrahydrophthalic anhydride and 0.13 g of benzyldimethylamine are mixed and used in further experiments. The formulation contains 85% of the theoretical hardener amount. The gel time is 22′21″ at 120° C. and 12′32″ at 130° C. The viscosity is 805 mPa at 25° C.

### Example 4

53.91 of isosorbide diglycidyl ether, 45.95 of methyltetrahydrophthalic anhydride and 0.14 g of benzyldimethylamine are mixed and used in further experiments. The formulation contains 85% of the theoretical hardener amount. The gel time is 9′28″ at 120° C. and 5′00″ at 130° C. The viscosity is 523 mPa at 25° C.

Curing Experiments

If comparative example 3 is cured for 3 hours at 120° C., the moulding material has a Shore D hardness of 76. If the curing is carried out at 130° C., the value is 78, i.e. there is no change.

For the mixture from example 4, the corresponding Shore D hardnesses are 77 for both curings.

### Comparative Example 5

52.91 of bisphenol A diglycidyl ether, 46.95 of methylhexahydrophthalic anhydride and 0.14 g of benzyldimethylamine are mixed and used in further experiments. The formulation contains 85% of the theoretical hardener amount. The gel time is 19′11″ at 120° C. and 11″ at 130° C. The viscosity is 643 mPa at 25° C.

### Example 6

49.38 of isosorbide diglycidyl ether, 50.47 of methylhexahydrophthalic anhydride and 0.15 g of benzyldimethylamine are mixed and used in further experiments. The formulation contains 85% of the theoretical hardener amount. The gel time is 9′22″ at 120° C. and 4′39″ at 130° C. The viscosity is 408 mPa at 25° C.

Stators of size 90 are impregnated with the resins from examples 2, 4 and 6. Following a dripping phase, the stators are cured for two hours at 160° C. Subsequently they are sawn up. All show full, bubble-free impregnation of the copper windings.

### Example 7

In a dissolver, a homogeneous mixture is prepared from 108.6 g of a phthalate-free plasticizer, 526.9 g of isosorbide diglycidyl ether, 1.0 g of fumed silica, 0.1 g of a commercially available silicone-containing antifoam, 342.9 g of chalk, 20 g of a black pigment paste and 1.4 g of benzyldimethylamine. The mixture has a viscosity of 4800 mPa at 23° C. Following addition of 449.2 g of methyltetrahydrophthalic anhydride, the mixture is homogenised and various specimens are prepared. The breakdown voltage is 32 kV/mm (according to IEC 60 243-1 in conjunction with IEC 60 455-2). The tracking index is 600 (according to IEC 60 112 in conjunction with 60 455-2). The impact resistance is 12 kJ/m² (according to ISO 179).

### Example 8

916 g of isosorbide diglycidyl ether are mixed with 1 g of a wetting additive, 1 g of a levelling aid and 37 g of a commercially available boron trichloride-amine complex. A 70×2×1 cm Roebel bar which has been wrapped with seven semi-overlapping (14 layers) of commercially available mica/glass ribbon, is impregnated with this mixture using the vaccum-pressure method (0.1 bar vacuum/1 hour followed by 6 bar pressure/5 hours). The bar is cured for 6 hours at 160° C. One bar is sliced open. The impregnation is homogeneous and complete up to the copper.

The dielectric permittivity loss factor is 0.0031 at 6 kV and 0.0036 at 10 kV. The permittivity loss factor is temperature-dependent and is 0.0031 at 21° C., 0.0096 at 90° C., 0.0326 at 130° C. and 0.1498 at 155° C.

1-13. (canceled)

14. A method of use of an electrical insulating resin comprising
A) isohexidediol diglycidyl ether
B) a hardener
C) an optional filler
D) further optional additives,
comprising the step of introducing the electrical insulating resin, into the windings of an electrical machine by dipping, dip rolling, trickling, pouring, vacuum or vacuum-pressure impregnation, followed by therman curing.

15. A method of use according to claim 14, characterized in that the isohexidediol diglycidyl ether is an isosorbide diglycidyl ether, isomannide diglycidyl ether or isoidide diglycidyl ether.

16. A method of use according to claim 14, characterized in that the hardener B) comprises one or more dicarboxylic or dicarboxylic anhydrides.

17. A method of use according to claim 16, characterized in that the hardener B) comprises methyltetrahydrophthalic anhydride or methylhexahydrophthalic anhydride.

18. A method of use according to claim 14, characterized in that the resin comprises a reaction accelerator.

19. A method of use according to claim 14, characterized in that the resin comprises a filler.

20. A method of use according to claim 19, characterized in that the filler is selected from the group consisting of dolomite, chalk, fused silica, quartz flour, aluminium hydroxide, magnesium hydroxide and mixtures thereof.

21. A method of use according to claim 14, characterized in that the hardener B) comprises a Lewis acid.

22. A method of use according to claim 21, characterized in that the hardener B) comprises a boron trichloride-amine complex.

23. A method of use according to claim 14 for impregnating electrical machines.

24. A method of use claim 23 for impregnating high-voltage electrical machines.

25. A method of use according to claim 14 for encapsulating transformers, coils, for fully encapsulating electric motors and for producing high-voltage insulators.

26. A method of use according to claim 15, characterized in that the hardener B) comprises one or more dicarboxylic or dicarboxylic anhydrides.
